(19) United States
(12) Patent Application Publication
(10) Pub. No.: US 2024/0276955 A1
(43) Pub. Date: Aug. 22, 2024

(54) SMALL SEED CONVERTER FOR BIRD FEEDER

(71) Applicant: CLASSIC BRANDS, LLC, DENVER, CO (US)

(72) Inventors: Robert W. Donegan, Denver, CO (US); Bryan Krueger, Denver, CO (US); John W. Bruno, Parker, CO (US)

(73) Assignee: CLASSIC BRANDS, LLC, DENVER, CO (US)

(21) Appl. No.: 18/650,425

(22) Filed: Apr. 30, 2024

Related U.S. Application Data
(63) Continuation of application No. 16/818,911, filed on Mar. 13, 2020, now Pat. No. 11,968,962.
Application No. 16/818,911 is a continuation of application No. 14/531,755, filed on Nov. 3, 2014, now Pat. No. 10,609,908.
(60) Provisional application No. 61/899,044, filed on Nov. 1, 2013.

(51) Int. Cl. A01K 39/012; A01K 39/01; A01K 39/02; A01K 39/04; F16M 13/02

(52) U.S. Cl. CPC A01K 39/012; A01K 39/0113; A01K 39/0206; A01K 39/04; F16M 13/02

(57) ABSTRACT

Implementations described and claimed herein provide apparatuses and methods for facilitating filling and cleaning of bird feeders that are aesthetically pleasing and adaptable for attracting different types of birds. In one implementation, a bird feeder includes a port having a surface extending from a proximal end to a distal end. The proximal end has a connecting portion configured to connect to a reservoir. The surface has one or more openings defined therein. A small seed converter is insertable into the port, and the small seed converter includes a plurality of teeth extending from an edge. The plurality of teeth are configured to narrow the one or more openings for dispensing small sized seed.

### CROSS-REFERENCE TO RELATED APPLICATIONS

The present application is a continuation of and claims the benefit of priority under 35 U.S.C. §§ 111 and 120 to U.S. Non-Provisional application Ser. No. 16/818,911 filed on Mar. 13, 2020, which is a continuation of and claims the benefit of priority under 35 U.S.C. §§ 111 and 120 to U.S. Non-Provisional application Ser. No. 14/531,755 entitled filed on Nov. 3, 2014, which claims benefit of priority under 35 U.S.C. § 119 to U.S. Provisional Patent Application No. 61/899,044, filed on Nov. 1, 2013. Each of these applications is incorporated by reference in its entirety herein.

### BACKGROUND

Many bird feeders configured to dispense seeds are difficult to clean and fill. Such bird feeders often have openings for receiving seed that are small and/or obstructed by components of the bird feeder, significantly increasing the challenge of filling the bird feeder without spilling the seed. Additionally, many bird feeders fail to adapt to a user's desire to attract different types of birds. For example, many bird feeders are only able to accommodate large seed or accommodate small seed. Accordingly, if the user purchases a large seed bird feeder and later wishes to attract birds that eat small seeds, the user must generally purchase another bird feeder entirely that is configured to dispense small seeds. Conventional bird feeders attempting to address these challenges often sacrifice appearance and quality of design, which is an important feature to users.

It is with these observations in mind, among others, that various aspects of the present disclosure were conceived and developed.

### BRIEF SUMMARY

Implementations described and claimed herein address the foregoing problems by providing apparatuses and methods for facilitating filling and cleaning of bird feeders that are aesthetically pleasing and adaptable for attracting different types of birds. In one implementation, a bird feeder includes a port having a surface extending from a proximal end to a distal end. The proximal end has a connecting portion configured to connect to a reservoir. The surface has one or more openings defined therein. A small seed converter is insertable into the port, and the small seed converter includes a plurality of teeth extending from an edge. The plurality of teeth are configured to narrow the one or more openings for dispensing small sized seed.

In another implementation, a bird feeder includes a cap engaging portion, a mouth, and an elongated body. The cap engaging portion has a proximal opening defined by a proximal edge. The cap engaging portion has a proximal surface extending distally from the proximal edge with one or more proximal engagers disposed on the proximal surface. The one or more proximal engagers are configured to engage a hanger assembly. The mouth has a distal opening defined by a distal edge. The mouth has a distal surface extending proximally from the distal edge with one or more distal engagers disposed on the distal surface. The one or more distal engagers configured to engage a basin assembly. The elongated body extends between the cap engaging portion and the mouth.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 shows a perspective view of an example bird feeder that facilitates filling and reduces spillage of seed.

FIG. 2 illustrates an exploded view of an example basin assembly having a small seed converter for the bird feeder of FIG. 1.

FIG. 3 displays a detailed assembled view of the small seed converter and feeding port of the basin assembly of FIG. 2.

FIG. 4 shows an exploded view of an example hanger assembly for the bird feeder of FIG. 1.

FIGS. 5 and 6 illustrate a top perspective view and a bottom perspective view, respectively, of an example bottle for the bird feeder of FIG. 1.

FIG. 7A is a front view of the bird feeder of FIG. 1 with a decorative cage and roof assembly.

FIGS. 7B and 7C are top perspective and bottom perspective views, respectively, of the bird feeder of FIG. 7A.

FIG. 7D shows a side view of the bird feeder of FIG. 7A.

FIGS. 7E and 7F show top and bottom views, respectively, of the bird feeder of FIG. 7A.

FIG. 8A is an isometric view of another example bird feeder that facilitates filling and reduces spillage of seed.

FIG. 8B is a side view of the bird feeder of FIG. 8A.

FIGS. 8C and 8D are top and bottom views, respectively, of the bird feeder of FIG. 8A.

FIGS. 9A and 9B show isometric views of the bird feeder of FIG. 8A with the hanger assembly removed for clarity with a small seed converter removed and inserted, respectively.

FIG. 10 shows a base of the bird feeder of FIG. 8A with the small seed converter inserted.

FIG. 11 shows the small seed converter of FIG. 10.

FIG. 12 illustrates a perspective view of an example nectar bird feeder that facilitates filling and reduces spillage.

FIG. 13 shows an exploded view of a hanger assembly and bottle of the nectar bird feeder of FIG. 12.

FIG. 14 shows a detailed view of the hanger assembly and the bottle of the nectar bird feeder of FIG. 13 assembled.

FIG. 15 displays the nectar bird feeder of FIG. 12 positioned to receive nectar.

FIG. 16 illustrates a perspective view of another example nectar bird feeder that facilitates filling and reduces spillage.

FIG. 17 shows an exploded view of a hanger assembly and bottle of the nectar bird feeder of FIG. 5.

FIG. 18 shows a detailed assembled view of the hanger assembly and the bottle of the nectar bird feeder of FIG. 17.

FIG. 19 displays the nectar bird feeder of FIG. 5 positioned to receive nectar.

FIG. 20 illustrates an example basin assembly for a nectar bird feeder.

### DETAILED DESCRIPTION

Aspects of the present disclosure involve apparatuses and methods for facilitating filling and cleaning of bird feeders that are aesthetically pleasing and adaptable for attracting different types of birds. In one aspect, a bird feeder adapted to hold and dispense seed is provided. The seed bird feeder includes a bottle, a hanger assembly, and a basin assembly. To facilitate filling and cleaning, the bottle includes a wide mouth opening at a first end of the bottle and an opening at the opposing end of the bottle through which to dispense the seed into the basin assembly for access by one or more birds. The hanger assembly includes a removable cap that engages the wide mouth opening of the bottle. The cap may be removed to access an interior of the bottle for cleaning or filling. The basin assembly includes a small seed converter that may be optionally used to dispense small seeds, such that the user may choose which birds to attract.

In some aspects, the bird feeders have a decorative, antique appearance with a glass bottle and metal accent finishing to provide an attractive, upscale appearance that is appealing to users. The bottles may be a variety of colors with different engravings or other decorative features. For example, the bird feeders may have features similar to those shown in U.S. Design patent application Ser. No. 29/438,289, entitled “Bottle for a Wild Bird Feeder” and filed on Nov. 28, 2012, which is incorporated herein in their entirety. Furthermore, the bird feeders may include other decorative features such as a cage and/or roof assembly or have a decorative, lantern-like appearance.

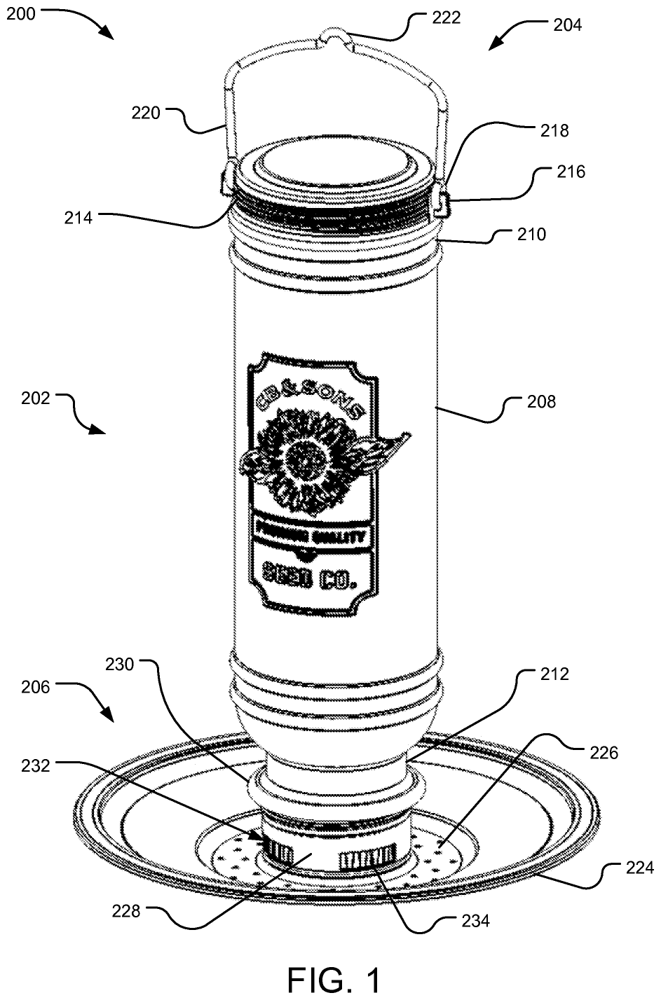

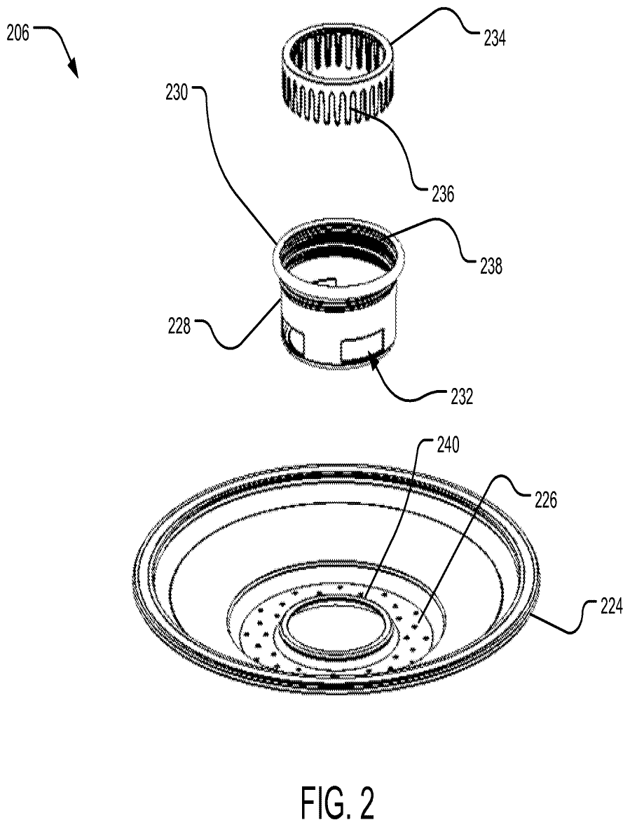

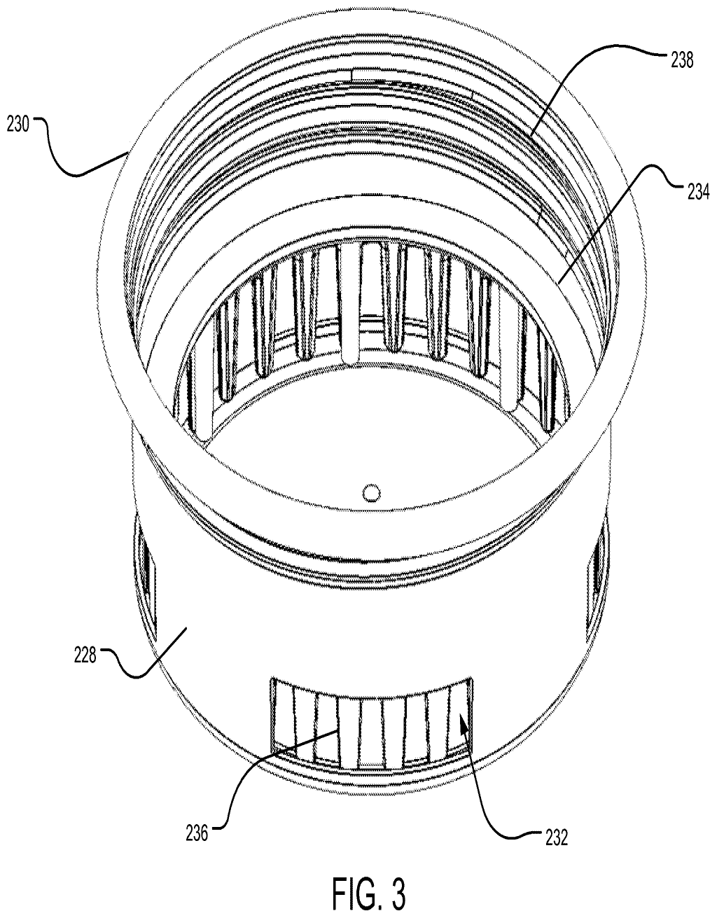

For a detailed description of an example seed bird feeder 200, reference is made to FIGS. 1-6. As can be understood from FIG. 1, which shows a perspective view of the seed bird feeder 200, a reservoir 202 is configured to hold bird food, which may various types and sizes of seeds. The seed bird feeder 200 further includes a hanger assembly 204 and a basin assembly 206. The seed bird feeder 200 facilitates disassembly to allow for quick cleaning.

The reservoir 202 is a bottle that may be made from a variety of materials, including but not limited to glass, metal, ceramics, plastics, or the like, and include one or more decorative features. To increase aesthetic appeal, the reservoir 202 may be made from glass that includes different decorative features, such as color, engraving, or other designs.

In one implementation, the reservoir 202 includes an elongated portion 208, a cap engaging portion 210, and a mouth 212 that may be tapered to dispense seed into the basin assembly 206. The reservoir 202 may be a variety of shapes and sizes. For example, the reservoir 202 may be an elongated tube with a generally cylindrical shape. However, other shapes are contemplated, including, without limitation, generally cylindrical, conical, cubical, contoured, angular, or the like. Further, the reservoir 202 may be adapted to hold various capacities of seed. For example, the reservoir 202 may be adapted to hold approximately 1.5 pounds of seed. However, other sizes are contemplated that maximize the capacity of seed without sacrificing the ability to hang the seed bird feeder 200 in various locations.

As can be understood from FIG. 1, in one implementation, the hanger assembly 204 includes a cap 214 and a hanger 220. The hanger assembly 204 may be made from a variety of materials, including but not limited to metal, glass, ceramics, plastics, or the like, and include one or more decorative features. To increase aesthetic appeal, the hanger assembly 204 may be made from a metal having decorative features, such as color (e.g., pewter), engravings, designs, or the like.

The cap 214 may be sized and shaped to mirror the size and shape of the cap engaging portion 210 of the reservoir 202, and the hanger 220 may be sized and shaped to adequately hold the seed bird feeder 200 when suspended. In one implementation, the cap 214 includes an engaging member 216 adapted to receive an engaging member 218 of the hanger 220. In one implementation, the hanger 220 includes a hanging portion 222 that permits the hanger 220 to securely attach and suspend the seed feeder 200 from an item, such as a tree limb, hook, or the like.

The basin assembly 206 is adapted to permit one or more birds to access the seed. The basin assembly 206 may be made from a variety of materials, including but not limited to metal, glass, ceramics, plastics, or the like, and include one or more decorative features. To increase aesthetic appeal, the basin assembly 206 may be made from a metal having decorative features, such as color (e.g., pewter), engravings, designs, or the like.

As can be understood from FIGS. 1-3, in one implementation, the basin assembly 206 includes a perch 224 from which one or more birds may be positioned to access seed dispensed from the reservoir 202 into a basin 226 through one or more openings 232 in a port 228. In one implementation, the port 228 is engaged to the basin 226 using a receiver 240 extending from the basin 226. The size and shape of the port 228 may mirror the size and shape of the mouth 212 of the reservoir 202. Further, the port 228 may include a lip 230 having a connecting portion 238, for example, having helical threads, to engage the mouth 212 to close or occlude the reservoir 202. The one or more openings 232 may be sized to dispense large seeds, and if the user desires to attract birds that eat small seeds (e.g., thistle seeds), a small seed converter 234 having a plurality of teeth 236 may be inserted into the port 228 to narrow the openings 232 to dispense the small seeds.

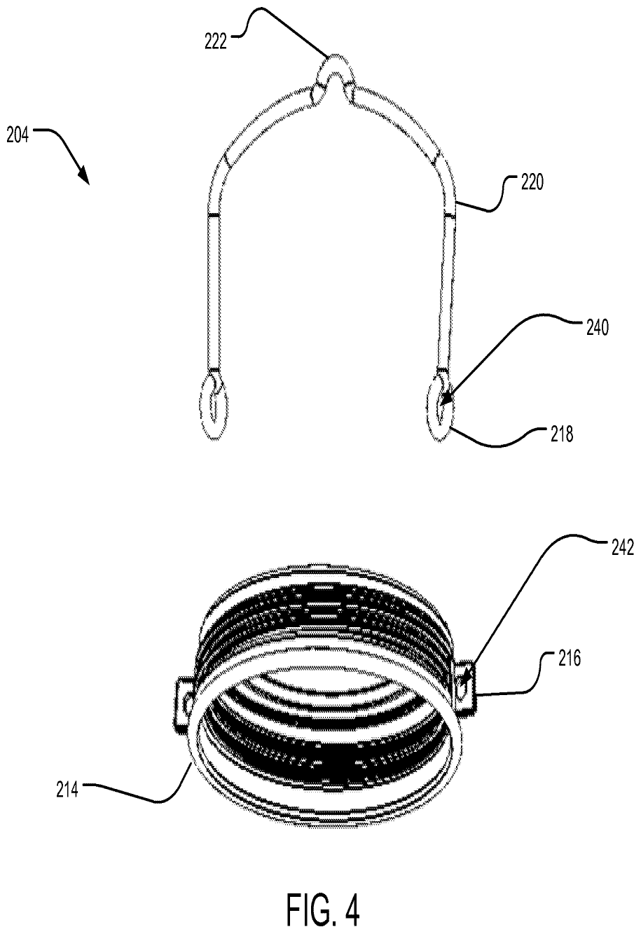

As can be understood from FIG. 4, which shows an exploded view of the hanger assembly 204, the engaging members 216 and 218 may be any engaging feature that permits the cap 214 to attach to the hanger 220 in a manner that allows the hanger 220 to move. For example, the engaging members 216 and 218 may each be hooks having openings 242, respectively, to engage one another in a manner that permits movement of the hanger 220.

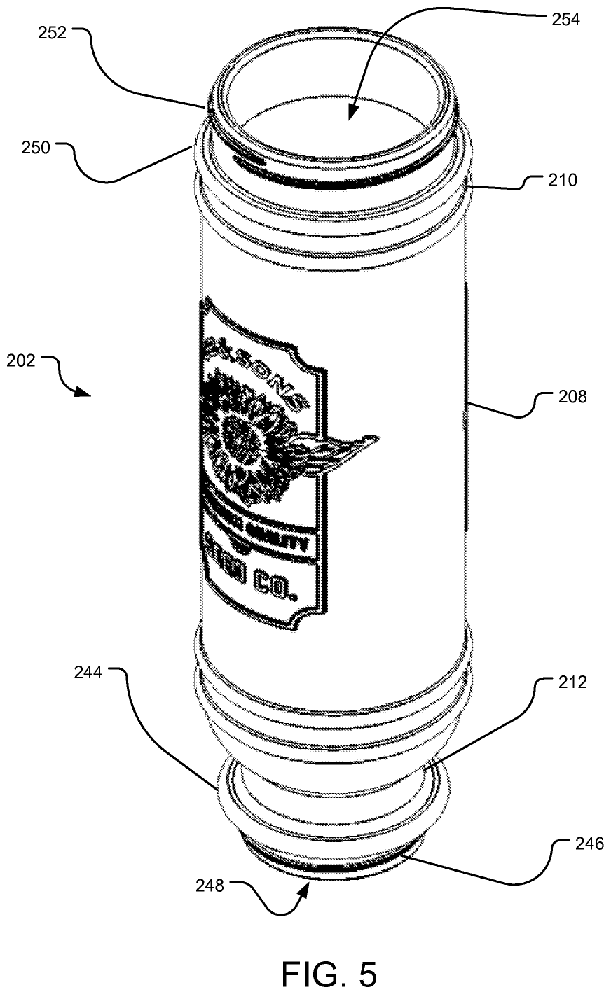

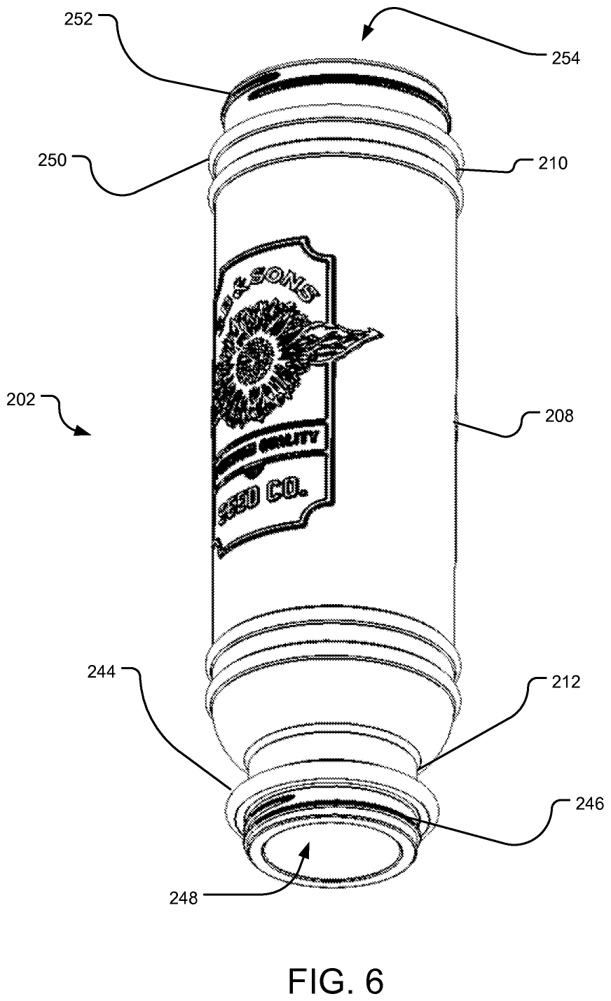

Turning to FIGS. 5 and 6, the reservoir 202 includes the elongated portion 208 extending between a first end and a second end. In one implementation, the reservoir 202 includes one or more decorative lips 250, for example, near the cap engaging portion 210, near the mouth 212, and/or along the elongated portion 208. The cap engaging portion 210 may further include one or more engagers 252, such as helical threads, disposed on a surface extending from a proximal edge defining an opening 254. The engagers 252 are configured to engage the hanger assembly 204. Similarly, the mouth 212 may further include one or more engagers 246, such as helical threads, to engage the port 228 of the basin assembly 206.

To facilitate cleaning and filling of the seed bird feeder 200, in one implementation, the reservoir 202 includes an opening at each end of the elongated portion 208. Stated differently, the cap engaging portion 210 includes the opening 254 and the mouth 212 includes an opening 248. As such, the reservoir 202 may be cleaned by running water from a hose or facet through one of the openings 254 and 248 into the reservoir 202 and out the other opening 254 and 248. Alternatively or additionally, the reservoir 202 may be cleaned using a dishwasher.

To fill the seed bird feeder 200, the cap 214 may be removed from the cap engaging portion 210 of the reservoir 202. The selected seed is then poured into the reservoir 202 through the opening 254, which may be relatively wide to prevent spillage. The cap 214 is then secured to the cap engaging portion 210 of the reservoir 202, and the seed bird feeder 200 is suspended using the hanger 220. Gravity forces the seed through the opening 248 of the mouth 212 to dispense seed into the basin assembly 206.

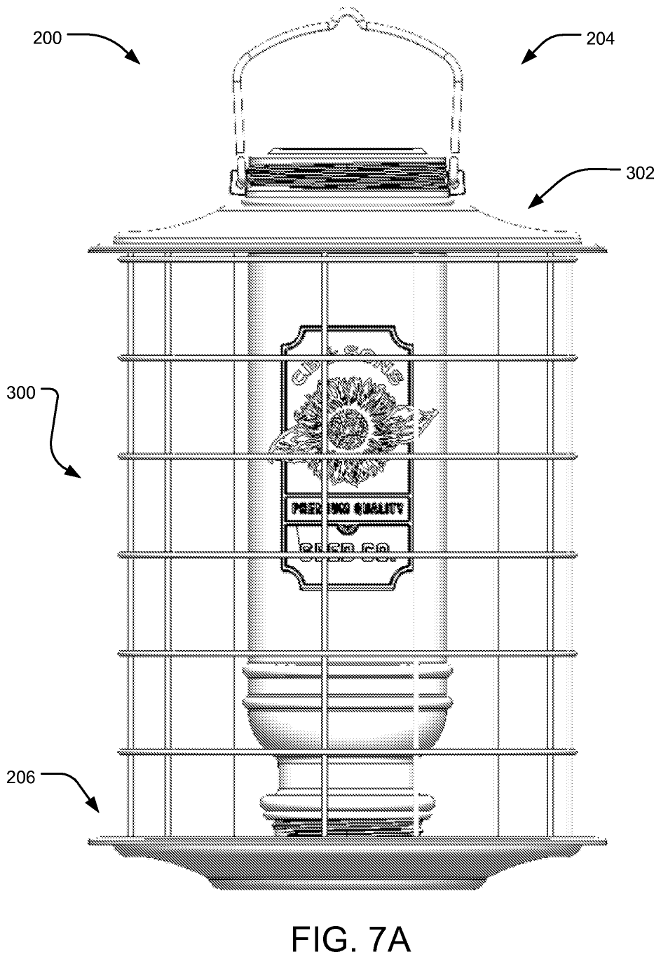

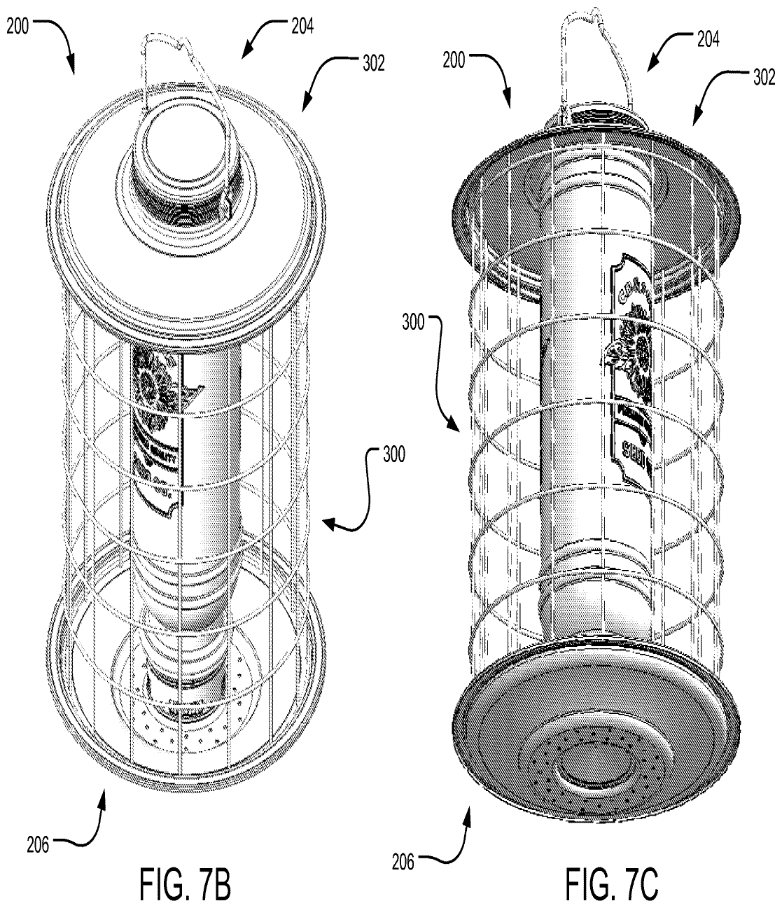

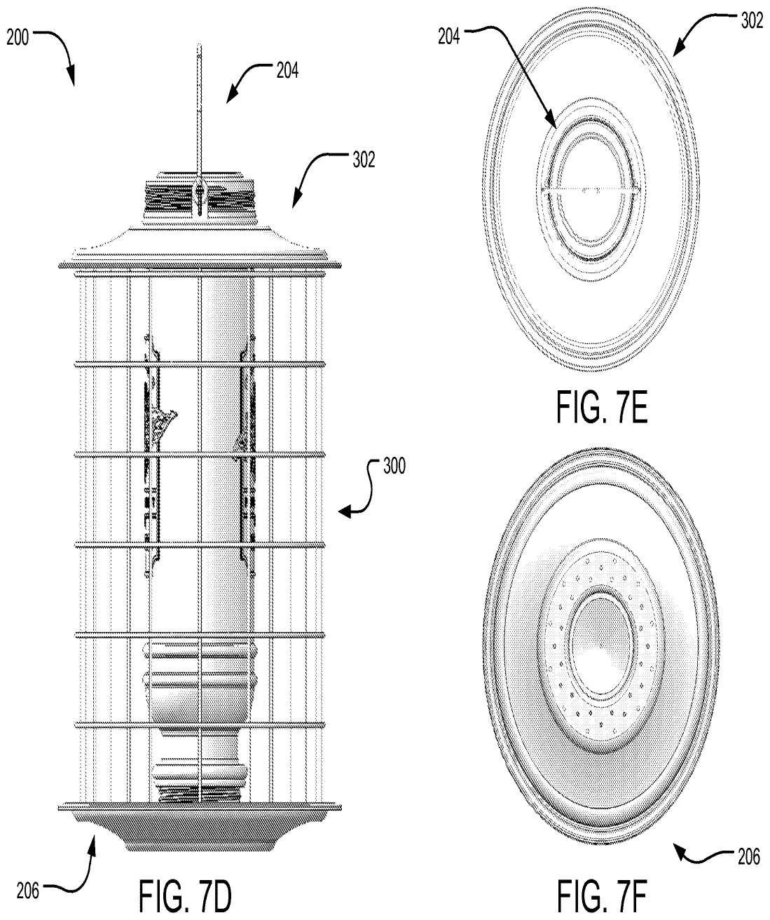

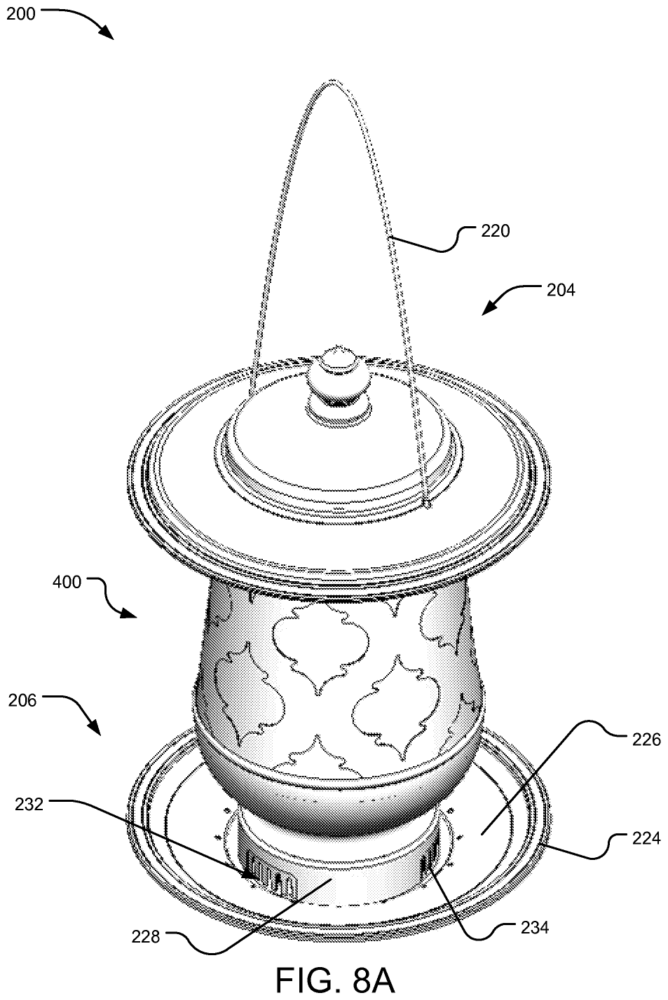

As shown in FIGS. 7A to 7F, the seed bird feeder 200 may be positioned within a decorative cage 300 for aesthetic appeal. In one implementation, the cage 300 is formed by a plurality of elongated rods extending vertically from the basin assembly 205 to a roof assembly 302 and a plurality of looped rods extending around the reservoir 202. There may be any number of the elongated rods and/or the looped rods of any shape or size according to design preferences. The roof assembly 302 may be disposed near the hanger assembly 204. In one implementation, the roof assembly slopes from the hanger assembly 204 to mirror the shape of the basin assembly 206. In some implementations, the cage 300 may discourage or prevent other animals or larger birds from reaching the dispensed seed.

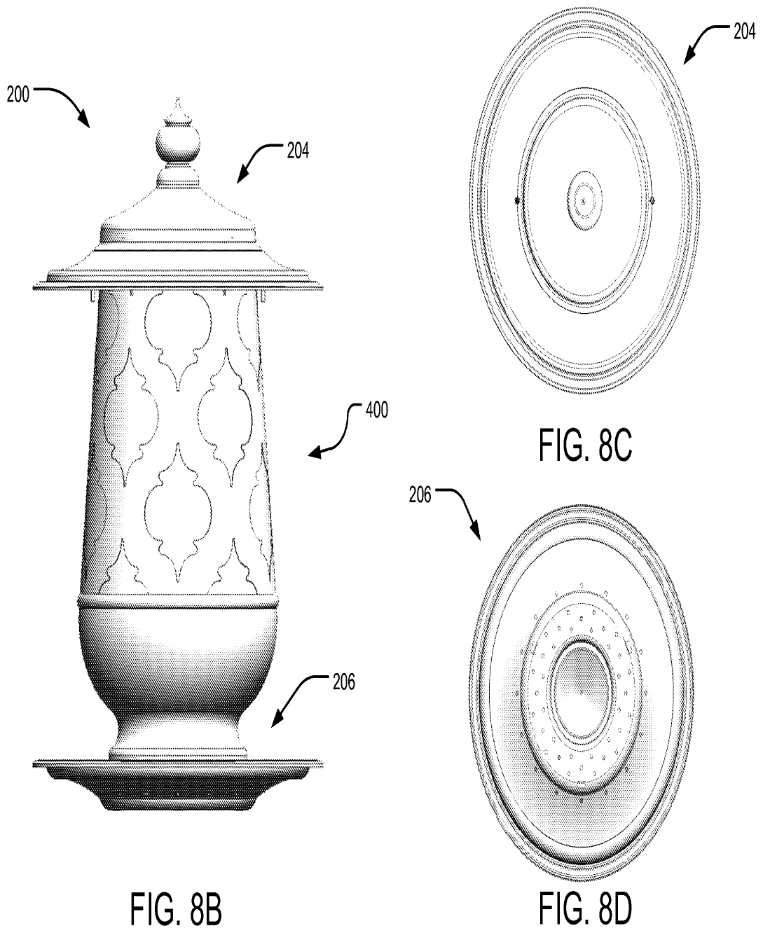

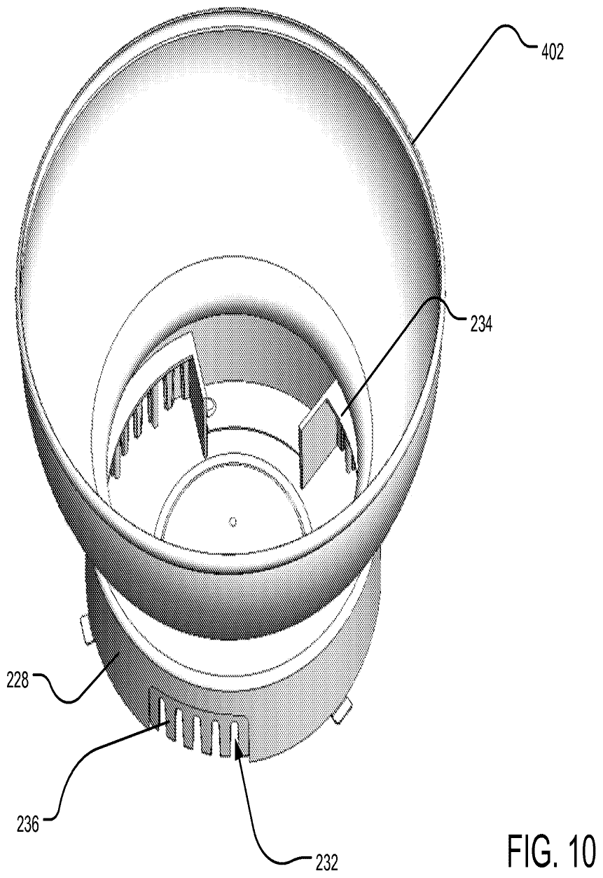

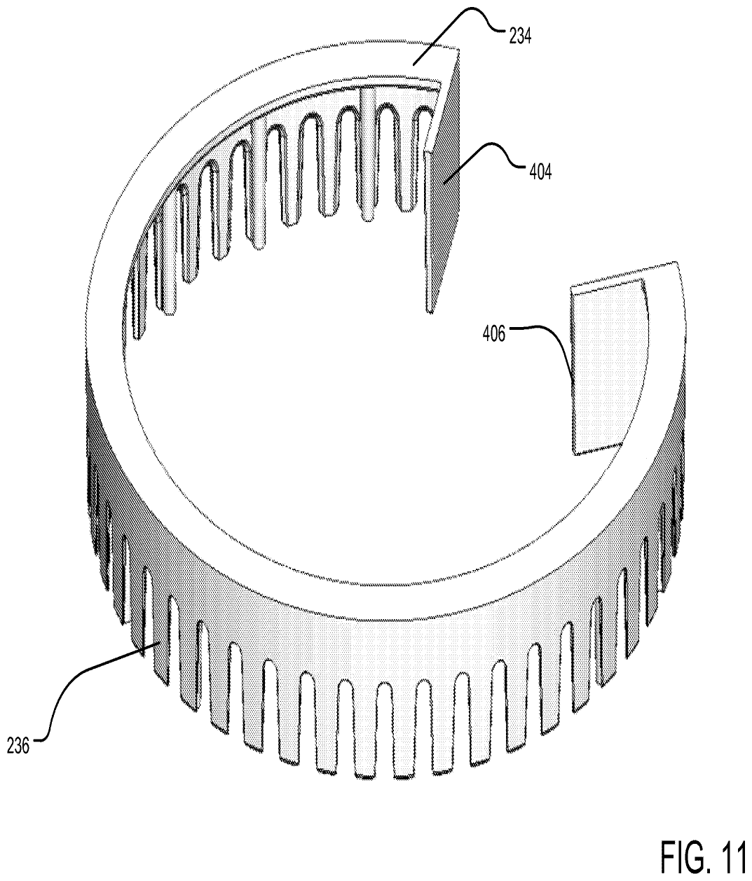

As can be understood from FIGS. 8A to 11, the small seed converter 234 may be used with various bird feeders having different aesthetic features. For example, the seed bird feeder 200 may include a reservoir 400 sized and shaped to resemble a lantern. The reservoir 400 may have a variety of patterns, designs, colors, or other decorative features.

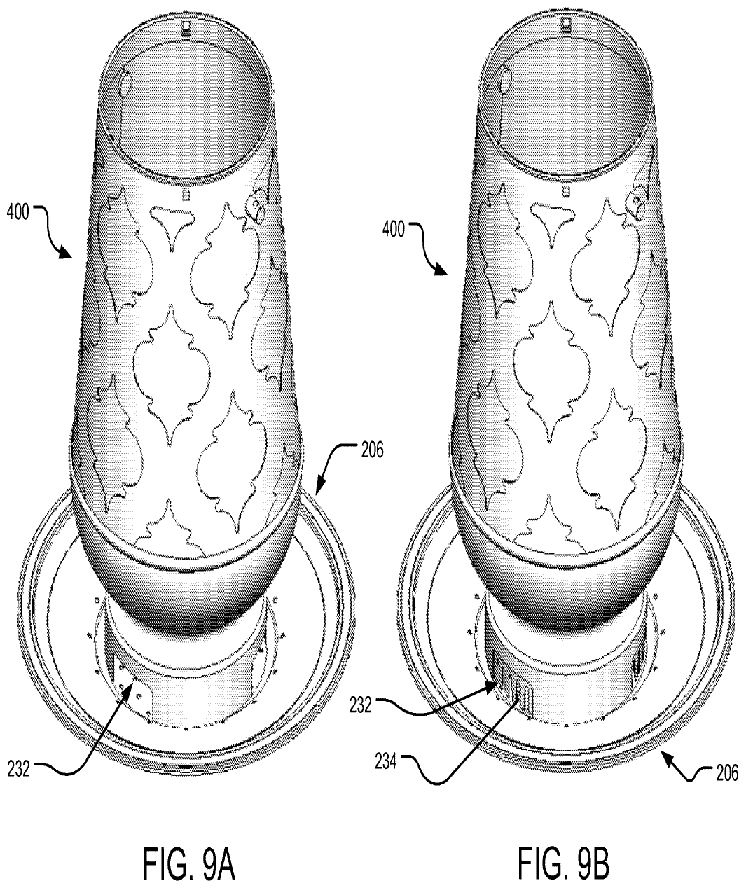

In one implementation, the reservoir 400 is configured to receive, hold, and dispense different sizes and types of bird seed depending on the preferences of the user. As can be understood from FIGS. 9A to 11, the seed is dispensed from the reservoir 400 into the basin assembly 206 through the one or more openings 232 in the port 228. In one implementation, the port 228 connects to or otherwise extends from a base 402 of the reservoir 400. The one or more openings 232 may be sized to dispense large seeds, and if the user desires to attract birds that eat small seeds (e.g., thistle seeds), the small seed converter 234 having a plurality of teeth 236 may be inserted into the port 228 to narrow the openings 232 to dispense the small seeds. In one implementation, the small seed converter 234 extends from a first end 404 to a second end 406. In another implementation, the small seed converter 234 includes a top edge that is substantially continuous, defining a circular, elliptical, rectangular, triangular, contoured, angled, and/or other shape.

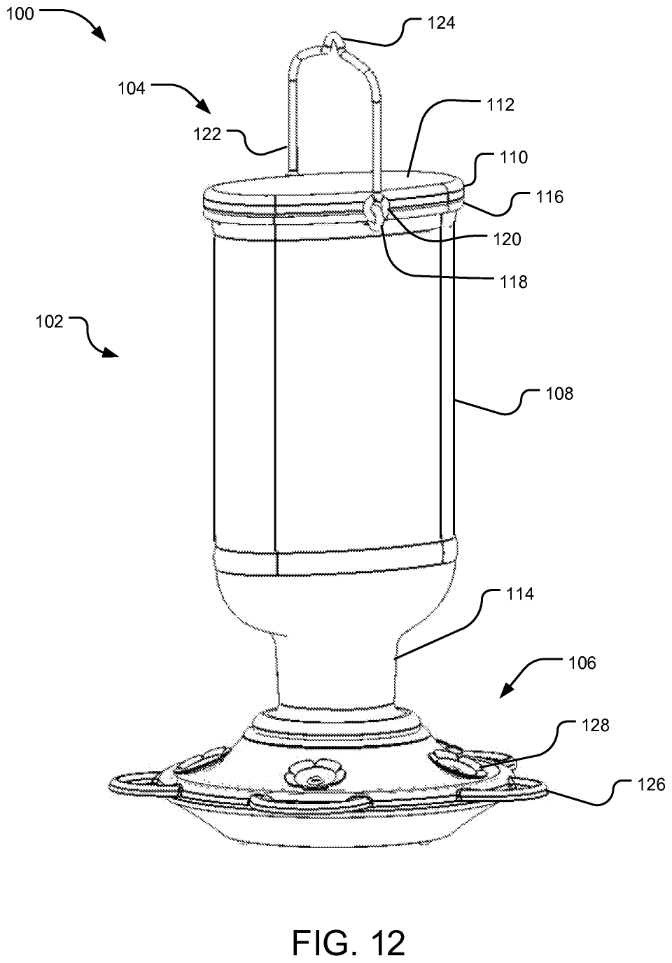

As can be understood from FIG. 12, which shows a perspective view of an example nectar bird feeder 100, a reservoir 102 is configured to hold bird food, which may nectar or the like. The nectar bird feeder 100 further includes a hanger assembly 104 and a basin assembly 106.

The reservoir 102 is a bottle that may be made from a variety of materials, including but not limited to glass, metal, ceramics, plastics, or the like, and include one or more decorative features. To increase aesthetic appeal, the reservoir 102 may be made from glass that includes different decorative features, such as color, engraving, or other designs.

In one implementation, the reservoir 102 includes an elongated portion 108, a lip 110, a substantially planar surface 112, and a mouth 114 that may be tapered to accept nectar with minimum spillage. The reservoir 102 may be a variety of shapes and sizes. For example, the elongated portion 108 may be longer along a longitudinal length of the reservoir 102 between the planar surface 112 and the mouth 114 relative a width and depth of the elongated portion 108. Further, the width of the elongated portion 108 may be longer relative to the depth of the elongated portion 108. These example features of the elongated portion 108, together with features of the mouth 114 and the planar surface 112, may create an overall flask-shaped appearance of the reservoir 102. However, other shapes are contemplated, including, without limitation, generally cylindrical, conical, cubical, contoured, angular, or the like. Further, the reservoir 102 may be adapted to hold various capacities of nectar. For example, the reservoir 102 may be adapted to hold approximately 10-25 oz. of nectar. However, other sizes are contemplated that maximize the capacity of nectar without sacrificing the ability to hang the nectar bird feeder 100 in various locations.

In one implementation, the hanger assembly 104 includes a reservoir engaging portion 116 and a hanger 122. The hanger assembly 104 may be made from a variety of materials, including but not limited to metal, glass, ceramics, plastics, or the like, and include one or more decorative features. To increase aesthetic appeal, the hanger assembly 104 may be made from a metal having decorative features, such as color (e.g., pewter), engravings, designs, or the like.

The reservoir engaging portion 116 may be sized and shaped to mirror the size and shape of the reservoir 102, and the hanger 122 may be sized and shaped to adequately hold the nectar bird feeder 100 when suspended. In one implementation, the reservoir engaging portion 116 has a hook 118 adapted to receive a hook 120 of the hanger 122. The hooks 118 and 120 may be any engaging feature that permits the reservoir engaging portion 116 to attach to the hanger 122 in a manner that allows the hanger 122 to pivot relative to the reservoir engaging portion 116. In one implementation, the hanger 122 includes a bulge 124 that permits the hanger 122 to securely attach to an item, such as a tree limb, hook, or the like.

The basin assembly 106 is adapted to permit one or more birds to access the nectar. The basin assembly 106 may be made from a variety of materials, including but not limited to metal, glass, ceramics, plastics, or the like, and include one or more decorative features. To increase aesthetic appeal, the basin assembly 106 may be made from a metal having decorative features, such as color (e.g., pewter), engravings, designs, or the like. In one implementation, the basin assembly 106 includes one or more perches 126, made from a durable integral metal or similar material, corresponding to one or more ports 128 through which a bird may access the nectar. The ports 128 may be removable to replaceable to attract different birds. For example, the ports 128 may be shaped like a flower to attract birds, such as hummingbirds, orioles, or the like, and may include an opening sized to accommodate the beak of the desired bird and prevent insects, such as bees, or animals from accessing the nectar. Orioles have bigger beaks than hummingbirds, so the opening may be larger to accommodate the oriole beak when attracting orioles. Similarly, the number of perches 126 and corresponding ports 128 included in the basin assembly 106 may vary depending on the type of bird attracted. For example, because orioles are larger birds, there may be fewer perches 126 and ports 128 includes when attracting orioles than when attracting hummingbirds.

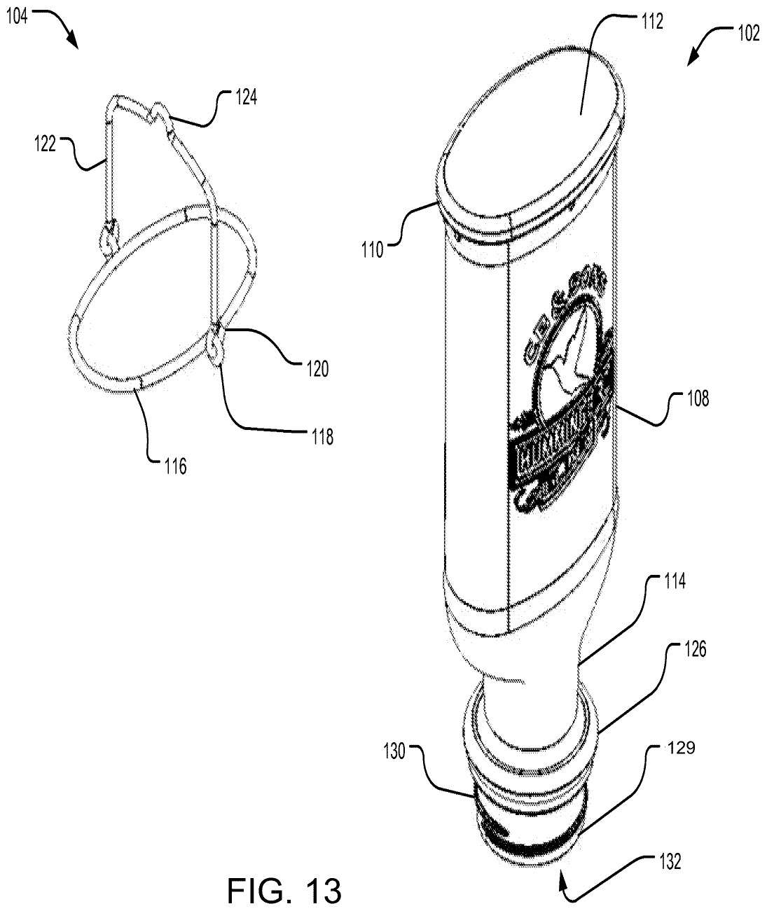

As can be understood from FIG. 13, the reservoir 102 may include various features near the mouth 114 to engage the basin assembly 106 and to facilitate filling. In one implementation, the mouth 114 tapers from the elongated portion 108 to a lip 110 which protrudes from the mouth 114 to secure components of the basin assembly 106 when engaged. The mouth 114 further includes a surface 129 having engaging features 130, such as helical threads, to engage the basin assembly 106 to close or occlude the reservoir 102. The mouth 114 includes a relatively wide opening 132 to accept nectar during filling with minimum spillage and to dispense the nectar into the basin assembly 106 when engaged.

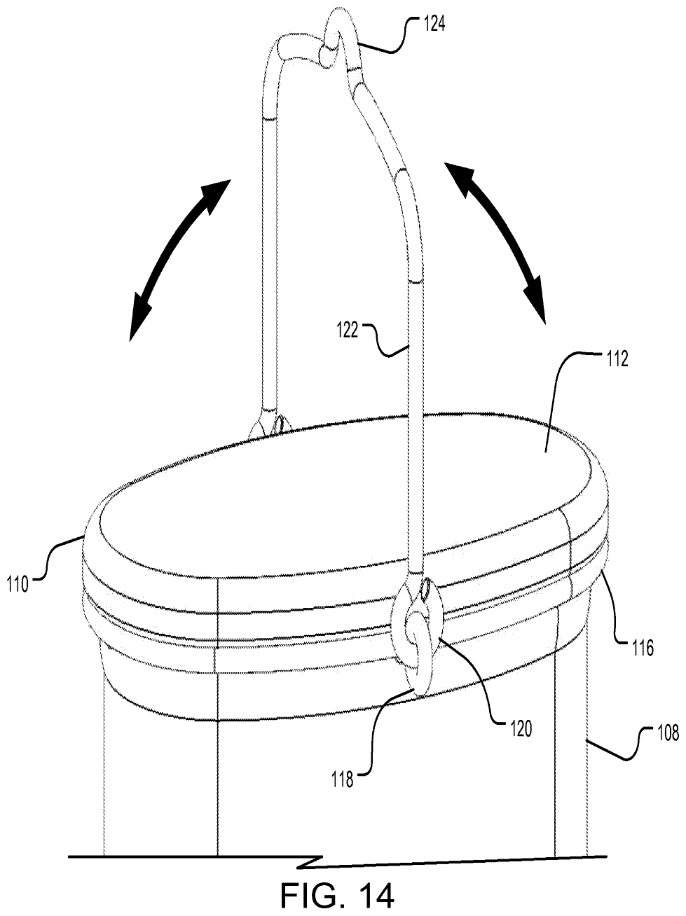

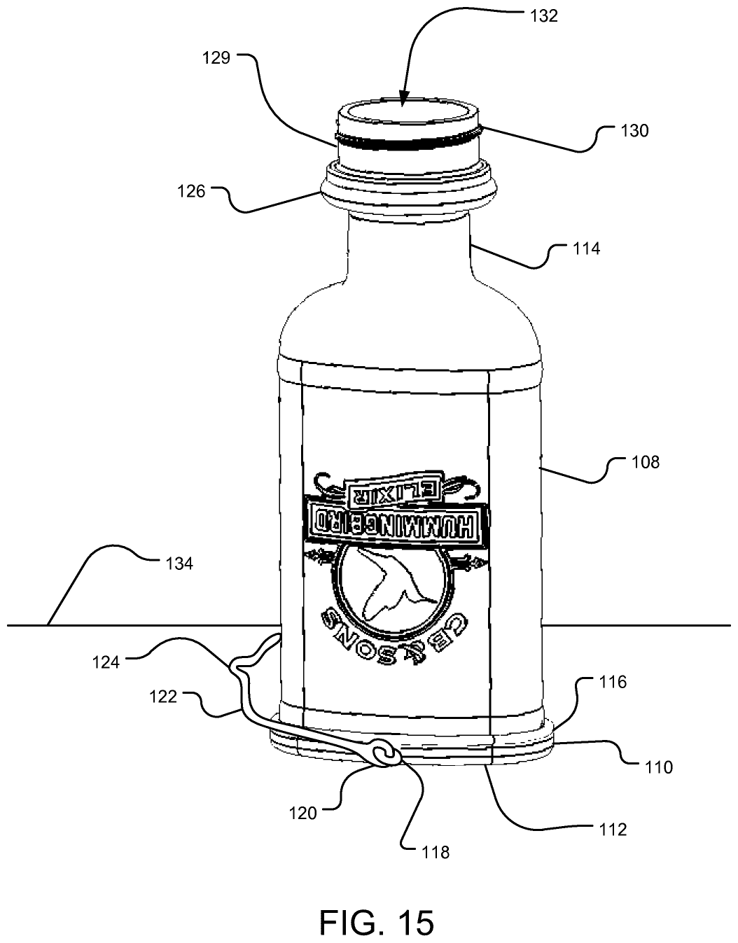

To engage the hanger assembly 104, the mouth 114 may be inserted or threaded through an opening formed by the reservoir engaging portion 116 and the hanger 122 when placed in a folded position. The hanger assembly 104 is then slid longitudinally along the length of the elongated portion 108 until the reservoir engaging portion 116 engages the lip 110 of the reservoir 102, as shown in FIG. 14. In one implementation, the reservoir engaging portion 116 engages the lip 110 along the elongated portion 108 such that the reservoir engaging portion 116 does not protrude past the planar surface 112 of the reservoir 102. The hanger 122 may then be pivoted into an upright position (e.g., shown in FIG. 13) for hanging or into a folded position (e.g., shown in FIG. 15) for removal, filling, or cleaning.

Turning to FIG. 14, arrows show the directions that the hanger 22 may pivot relative to the reservoir engaging portion 116 and the planar surface 112 of the reservoir 102, in one implementation. For example, as can be understood from FIG. 15, the hanger 122 may be pivoted into a folded position to provide unobstructed placement of the planar surface 112 of the reservoir 102 on a surface 134, such as a table. In this example, because the reservoir engaging portion 116 does not protrude past the planar surface 112 and the hanger 122 may fold such that the hanger 122 does not protrude past the planar surface 112, the reservoir 102 may be stably placed on the surface 134 during filling or cleaning.

As can be understood from FIG. 15, in one implementation, to fill the nectar bird feeder 100 to feed one or more birds, the nectar bird feeder 100 is inverted and the basin assembly 106 is removed. Inverting the nectar bird feeder 100 before removing the basin assembly 106 reduces spillage of any nectar held in the reservoir 102 and/or the basin assembly 106. The hanger 122 is pivoted into the folded position, and the planar surface 112 of the reservoir is placed on the surface 134. Nectar is then poured into the reservoir 102 through the opening 132, which is sized to accept the nectar with minimum spillage. Still in the inverted position, the basin assembly 106 is secured onto the mouth 114. The nectar bird feeder 100 may be flipped over and the hanger 122 pivoted into the upright position for hanging. In this position, gravity forces the nectar to dispense from the reservoir 102 into the basin assembly 106 for access by one or more birds.

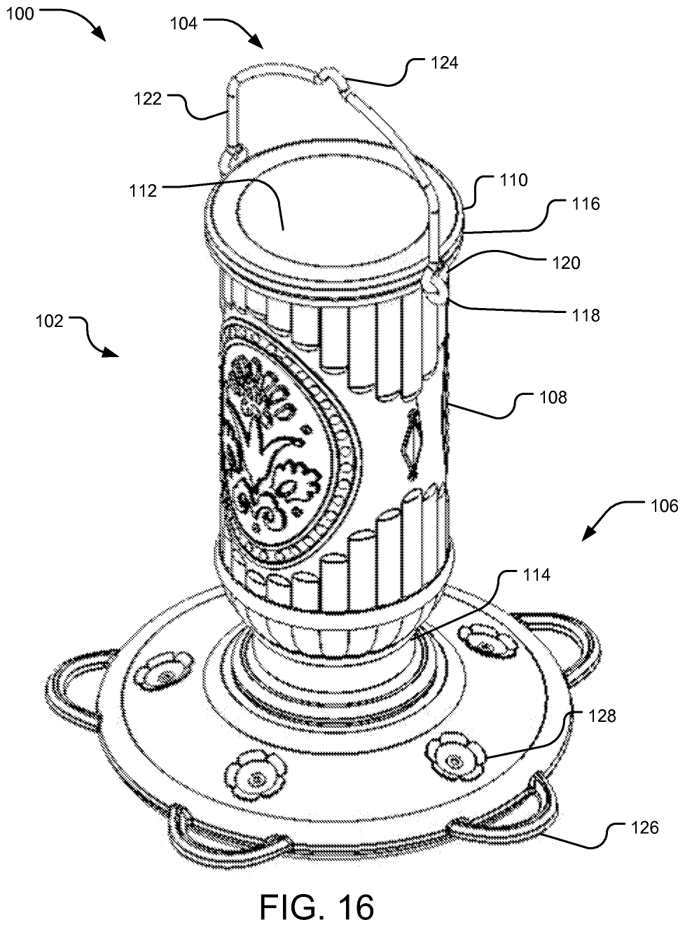

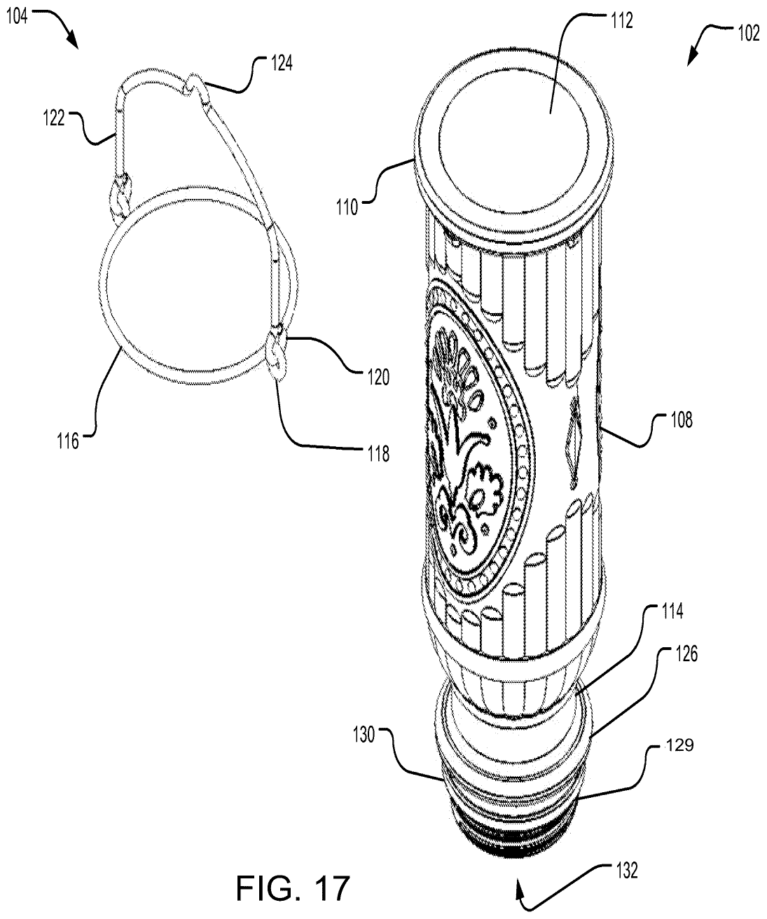

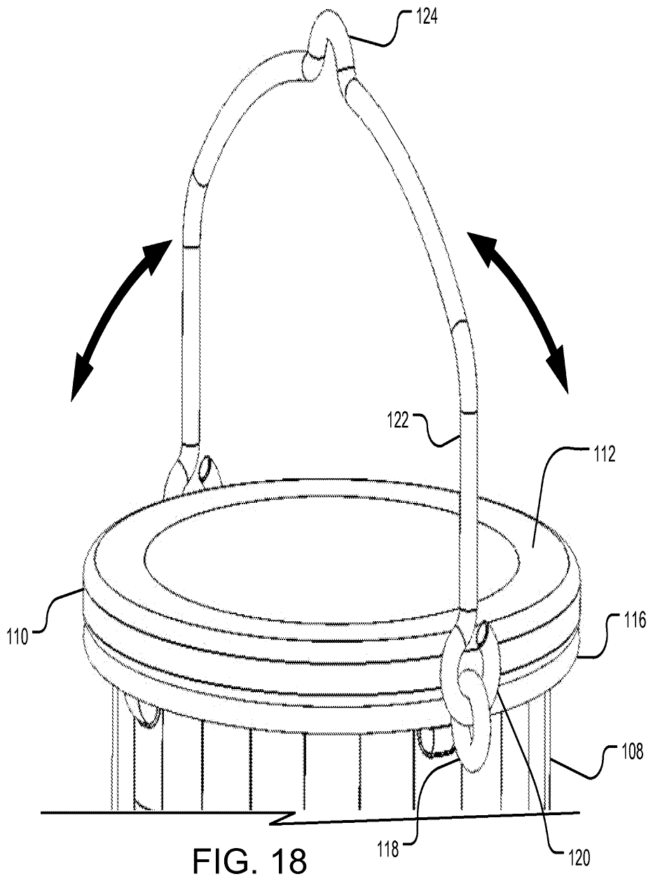

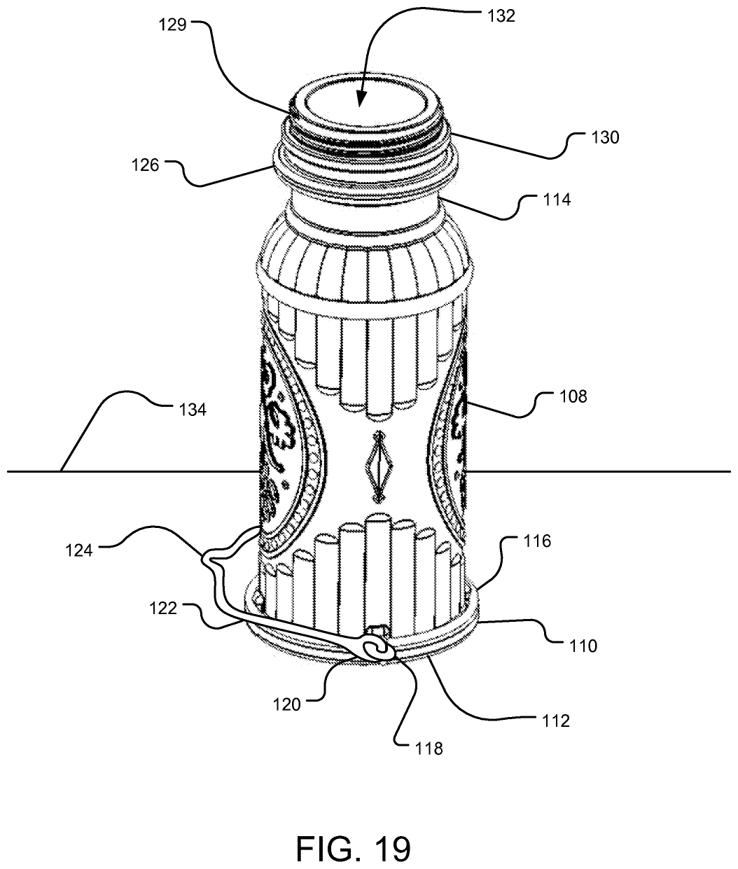

FIGS. 16-19 illustrate another implementation of the nectar bird feeder 100. As shown in FIGS. 16-19, the reservoir 102 may have a generally cylindrical shape with various decorative features, and the reservoir engaging portion 116 may be similarly shaped to engage the reservoir 102 along the elongated portion 108 near the lip 110.

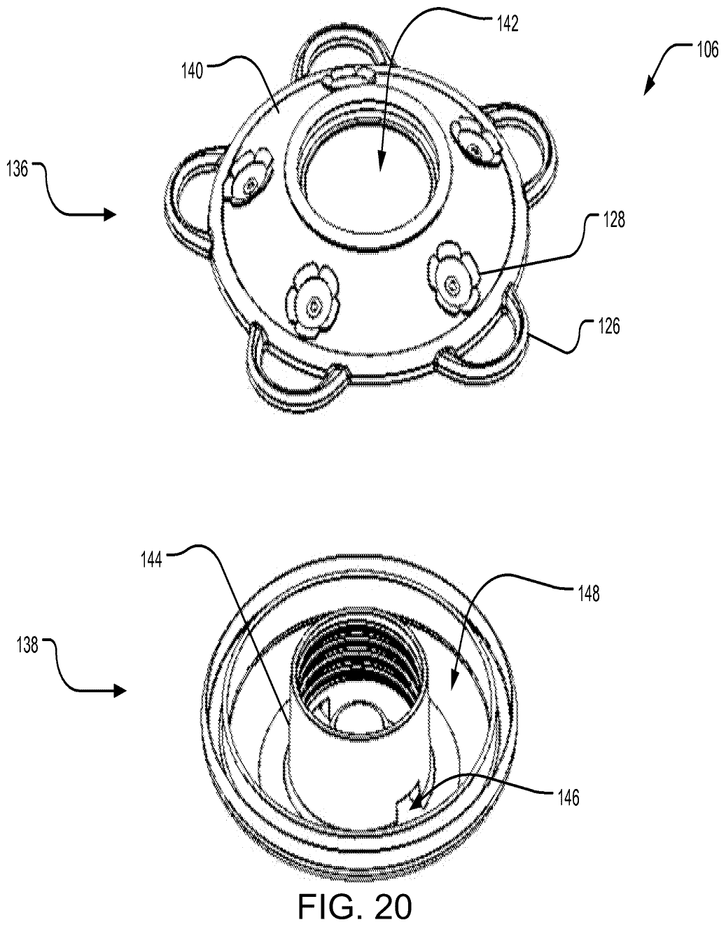

FIG. 20 shows an exploded view of the basin assembly 106. In one implementation, the basin assembly 106 includes a top portion 136 and a bottom portion 138. The top portion 136 includes a cover 140 for presenting the one or more ports 128 and from which the one or more perches 126 protrude. The top portion 136 covers the bottom portion 138 to prevent insects, such as bees, and animals from accessing the nectar and reduces loss of the nectar to evaporation. In one implementation, the top portion 136 includes an opening 142 in the cover 140 through which the mouth 114 of the reservoir 102 may be inserted to engage the bottom portion 138 to close or occult the reservoir 102 and dispense the nectar. In one implementation, the bottom portion 138 includes an engaging member 144 for engaging the mouth 114. Stated differently, the engaging member 144 may include features to receive and engage the engaging features 130, such as helical threads, of the surface 129 of the mouth 114 to close or occlude the reservoir 102. The engaging member 144 may include one or more openings 146 to controllably dispense nectar from the reservoir 102 into a basin 148. The nectar is dispensed using gravity to fill up the basin 148 such that one or more birds may access the nectar held in the basin 148 through the one or more ports 128.

Based upon design preferences, it is understood that the specific order or hierarchy of steps in the method can be rearranged while remaining within the disclosed subject matter. The accompanying method claims present elements of the various steps in a sample order and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

The above specification, examples, and data provide a complete description of the structure and use of example implementations of the invention. Various modifications and additions can be made to the exemplary implementations discussed without departing from the spirit and scope of the presently disclosed technology. For example, while the implementations described above refer to particular features, the scope of this disclosure also includes implementations having different combinations of features and implementations that do not include all of the described features. Accordingly, the scope of the presently disclosed technology is intended to embrace all such alternatives, modifications, and variations together with all equivalents thereof.

What is claimed is:

1. A bird feeder comprising:
a proximal edge extending around a central line and defining a plane;
an outer surface extending distally from the plane;
an inner surface connected to the outer surface by the proximal edge, the inner surface extending distally from the plane;
an opening formed by the proximal edge and positioned on the plane; and
a hanger disposed distal to and not intersecting the plane, the hanger having a hanging portion positioned on the central line.

2. The bird feeder of claim 1, wherein the proximal edge extends generally circular around the central line.

3. The bird feeder of claim 1, wherein the outer surface is generally smooth.

4. The bird feeder of claim 1, wherein the inner surface includes one or more engaging features configured to engage a proximal end of a reservoir.

5. The bird feeder of claim 4, wherein the one or more engaging features include at least one of helical threads, a lip, a protrusion, or a surface configured for a snap fit.

6. The bird feeder of claim 1 further comprising:
a first connector,
wherein the hanger includes a second connector, the second connector engaged to the first connector, the hanger configured to pivot to a folded position.

7. The bird feeder of claim 6, wherein the first connector and the second connector are at least one of hooks, slots, pegs, or ears.

8. The bird feeder of claim 6, wherein the first connector is disposed on the outer surface.

9. The bird feeder of claim 6, wherein the first connector is disposed on the inner surface.

10. A bird feeder comprising:
a body configured to receive fluid;
an opening formed by an edge of the body and positioned on a first plane, the edge configured to meet a flat surface positioned on a second plane; and
a hanger having a hanging portion, the hanger configured to permit the first plane to substantially merge with the second plane when the edge meets the flat surface.

11. The bird feeder of claim 10, wherein the hanging portion is positioned relative to an approximate center of the first plane.

12. The bird feeder of claim 10, wherein the body includes one or more engaging features configured to engage a proximal end of a reservoir.

13. The bird feeder of claim 10, wherein the hanger is disposed distal to and not intersecting the first plane.

14. The bird feeder of claim 10, wherein:
the body includes a first connector, and
the hanger includes a second connector, the second connector engaged to the first connector such that the hanger is configured to pivot between an upright and a folded position.

15. The bird feeder of claim 14, wherein the first connector is disposed on an outer surface of the first connector.

16. A bird feeder comprising:
a reservoir configured to hold nectar, the reservoir having a mouth disposed opposite a planar surface, the mouth configured to dispense the nectar from the reservoir into a basin assembly; and
a hanger assembly having a hanger and a reservoir engaging portion configured to engage a connecting portion of the reservoir near the planar surface, such that a first connector engaged to a second connector are disposed distal to the planar surface, the hanger configured to pivot to a folded position with the hanger not protruding past the planar surface.

17. The bird feeder of claim 16, wherein the first connector and the second connector are each hooks.

18. The bird feeder of claim 16, wherein the connecting portion of the reservoir is a lip.

19. The bird feeder of claim 16, wherein the reservoir further includes an elongated portion.

20. The bird feeder of claim 16, wherein the reservoir is contoured.
